(19) United States
(12) Patent Application Publication
(10) Pub. No.: US 2022/0319256 A1
(43) Pub. Date: Oct. 6, 2022

(54) INFORMATION PROCESSING APPARATUS, VEHICLE, AND INFORMATION PROCESSING SYSTEM

(71) Applicants: TOYOTA JIDOSHA KABUSHIKI KAISHA, Toyota-shi (JP); DENSO CORPORATION, Kariya City (JP)

(72) Inventors: Yu NAGATA, Chofu-shi (JP); Hiroshi HIGASHIDE, Nagoya-shi (JP); Keiichi UNO, Kariya-city (JP)

(73) Assignees: TOYOTA JIDOSHA KABUSHIKI KAISHA, Toyota-shi (JP); DENSO CORPORATION, Kariya-city (JP)

(21) Appl. No.: 17/698,313

(22) Filed: Mar. 18, 2022

(30) Foreign Application Priority Data
Mar. 31, 2021 (JP) 2021-061862

(51) Int. Cl. G07C 5/08; H04L 67/12; G06Q 10/00; G07C 5/00

(52) U.S. Cl. CPC G07C 5/0808; H04L 67/12; G06Q 10/20; G07C 5/008

(57) ABSTRACT

An information processing apparatus includes a first communication interface, a first memory, and a first controller. The first communication interface is configured to be able to acquire failure diagnosis information for a vehicle. The first memory stores information on a plurality of services. The first controller is configured to select one or more services from the plurality of services stored in the first memory, based on the failure diagnosis information and on a priority evaluation category indicating an evaluation category for the plurality of services that is prioritized by a user. The first controller is configured to transmit information on the selected one or more services via the first communication interface.

### CROSS-REFERENCE TO RELATED APPLICATION

This application claims priority to Japanese Patent Application No. 2021-061862, filed on Mar. 31, 2021, the entire contents of which are incorporated herein by reference.

### TECHNICAL FIELD

The present disclosure relates to an information processing apparatus, a vehicle, and an information processing system.

### BACKGROUND

When failures occur in vehicles, such as autonomous vehicles, sometimes they may not be able to be driven at all or may not be able to be driven safely. Technology used in the event of failures in autonomous vehicles or the like has therefore been proposed. One example of disclosed technology relates to an autonomous driving system with redundant control systems that is configured to disable autonomous driving control if a failure occurs in one of the control systems when autonomous driving control is suspended (for example, Patent Literature 1).

### CITATION LIST

### Patent Literature

PTL 1: JP 2019-111866 A

### SUMMARY

According to the known technology, although some functions of the system are stopped upon occurrence of a failure in the vehicle, no method has been proposed for assisting a user in recovery from the failure. It is expected that convenience for the user will be improved if there is a system that assists in recovering the vehicle in which the failure has occurred.

It would be helpful to provide an information processing apparatus, a vehicle, and an information processing system that can assist a user in recovery from a failure when it occurs in the vehicle.

An information processing apparatus according to an embodiment of the present disclosure includes a first communication interface, a first memory, and a first controller. The first communication interface is configured to be able to acquire failure diagnosis information for a vehicle. The first memory stores information on a plurality of services. The first controller is configured to select one or more services from the plurality of services stored in the first memory, based on the failure diagnosis information and on a priority evaluation category indicating an evaluation category for the plurality of services that is prioritized by a user of the vehicle. The first controller is configured to transmit information on the selected one or more services to the user via the first communication interface.

A vehicle according to an embodiment of the present disclosure includes a second communication interface and a second controller. The second communication interface is configured to be communicable with the outside. The second controller is configured to be able to collect failure diagnosis information when a failure occurs, and transmit the failure diagnosis information directly or indirectly to an external information processing apparatus via the second communication interface. The second controller is further configured to transmit, to the information processing apparatus, vehicle use information indicating a mode in which the vehicle is used by a user of the vehicle. The second controller is configured to be able to acquire, from the information processing apparatus, information on one or more services that have been selected from a plurality of services based on the failure diagnosis information, a priority evaluation category indicating an evaluation category for the plurality of services that is prioritized by the user, and the vehicle use information.

An information processing system according to an embodiment of the present disclosure includes an information processing apparatus and a vehicle. The vehicle is configured to collect failure diagnosis information when a failure occurs, and transmit the failure diagnosis information to the information processing apparatus. The information processing apparatus is configured to store information on a plurality of services, and select one or more services from the plurality of services, based on the failure diagnosis information for the vehicle and on a priority evaluation category indicating an evaluation category for the plurality of services that is prioritized by a user of the vehicle. The information processing apparatus is configured to transmit information on the selected one or more services to the user.

According to the present disclosure, an information processing apparatus, a vehicle, and an information processing system that can assist a user in recovery from a failure when it occurs in the vehicle are provided.

### BRIEF DESCRIPTION OF THE DRAWINGS

In the accompanying drawings:

FIG. 1 is a block diagram illustrating a schematic configuration of an information processing system according to an embodiment of the present disclosure;

FIG. 2 is a block diagram illustrating a schematic configuration of an information processing apparatus in FIG. 1;

FIG. 3 illustrates an example of information on a service group stored in a first memory;

FIG. 4 illustrates an example of user information stored in the first memory;

FIG. 5 is a block diagram illustrating a schematic configuration of part of each vehicle in FIG. 1 that is relevant to the present information processing system;

FIG. 6 is a flowchart illustrating an example of processing executed by the information processing apparatus;

FIG. 7 is a block diagram illustrating a schematic configuration of an information processing system according to another embodiment of the present disclosure;

FIG. 8 illustrates an example of vehicle use information; and

FIG. 9 is a flowchart illustrating another example of processing executed by the information processing apparatus.

### DETAILED DESCRIPTION

Embodiments of the present disclosure will be described below, with reference to the drawings. The drawings used in the following description are schematic.

### First Embodiment

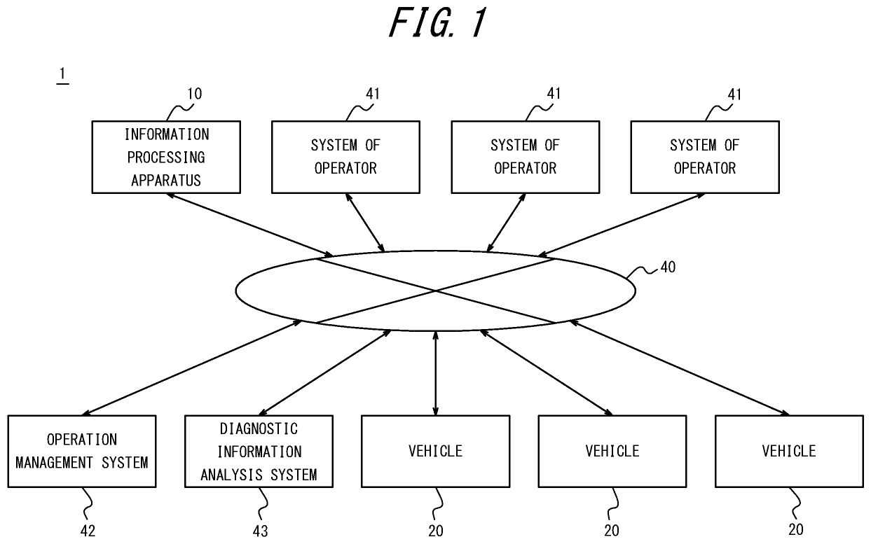

An information processing system 1 according to an embodiment of the present embodiment will be described with reference to FIG. 1 to FIG. 6.

(Overall Configuration)

As illustrated in FIG. 1, the information processing system 1 includes an information processing apparatus 10 and a plurality of vehicles 20. The information processing apparatus 10 and the plurality of vehicles 20 are configured to be communicable with each other via a communication network 40. When the vehicles 20 experience failures, the information processing apparatus 10 presents, to users of the vehicles 20, appropriate services for recovery from the failures. The plurality of vehicles 20 may include vehicles owned by individuals and vehicles owned by passenger transportation operators. In a case in which the vehicles 20 are vehicles owned by individuals, the information processing apparatus 10 may present services to in-vehicle information terminals installed in the vehicles 20 or to information terminals held by the users. In a case in which the vehicles 20 are vehicles owned by individuals, the users of the vehicles 20 refer to owners or drivers of the vehicles.

The information processing apparatus 10 is configured to be communicable with systems 41 of a plurality of service providing operators, via a network that is the same as or different from the communication network 40 used for communications with the vehicles 20. The information processing apparatus 10 can collect information on services provided by the respective service providing operators from the systems 41 of the operators. In a case in which users of vehicles 20 in which failures have occurred accept use of services presented by the information processing apparatus 10, the information processing apparatus 10 can instruct the service providing operators that provide the services to actually provide the services, via the systems 41 of the operators.

In a case in which the vehicles 20 are vehicles, such as buses or taxis, that provide passenger transportation services, the information processing apparatus 10 may be configured to be communicable with an operation management system 42 that manages operations of the vehicles 20, via the communication network 40. The operation management system 42 is capable of monitoring operations of the vehicles 20 and receiving signals indicating occurrence of failures from the vehicles 20. In this case, the information processing apparatus 10 may present services to the operation management system 42. In a case in which the vehicles 20 are passenger transportation vehicles owned by a passenger transportation operator, a user of each vehicle 20 refers to the operator that operates the vehicle 20.

Each vehicle 20 can be a vehicle that is compatible with autonomous driving. The autonomous driving may include, for example, any level from Level 1 to Level 5 as defined by the Society of Automotive Engineers (SAE), but is not limited to these, and may be defined in any way. Each vehicle 20 is capable of self-diagnosing the components of the vehicle 20 when a failure occurs. In the following, information obtained as a result of self-diagnosis is referred to as failure diagnosis information. The vehicle 20 can directly transmit the failure diagnosis information to the information processing apparatus 10. The vehicle 20 may be configured to transmit the failure diagnosis information to a diagnostic information analysis system 43 connected to the communication network 40. The diagnostic information analysis system 43 may translate code information indicating the failure diagnosis information for the vehicle 20 into data that is independent of the type and manufacturer of the vehicle 20, for transmission to the information processing apparatus 10. Accordingly, the vehicle 20 can indirectly transmit the failure diagnosis information to the information processing apparatus 10 via the diagnostic information analysis system 43.

When failures occur, sometimes the vehicles 20 may not be able to move, and other times they can be driven. In a case in which the vehicles 20 can be driven after occurrence of failures, the vehicles 20 may shift into an emergency driving mode that ensures safety. The vehicles 20 in which the failures have occurred may travel in the emergency driving mode to registered points, such as garages, by autonomous driving, in a case in which their current positions are close to the registered points. In a case in which the vehicles 20 can be driven after failures have occurred, the vehicles 20 may travel to repair shops that can be reached, in accordance with instructions from the users in the vehicles 20 or from the outside of the vehicles 20.

The information processing apparatus 10 is operated, for example, by an operator who has contracted with a plurality of service providing operators, and can guide appropriate services to the users of the vehicles 20 in which the failures have occurred. The services provided by the information processing apparatus 10 can be called “concierge services” for the users of the vehicle 20 that have experienced the failures.

The diagnostic information analysis system 43 may be operated by manufacturers, maintenance operators, or the like of the vehicles 20. The functions of the diagnostic information analysis system 43 may be included in the information processing apparatus 10.

(Configuration of Information Processing Apparatus)

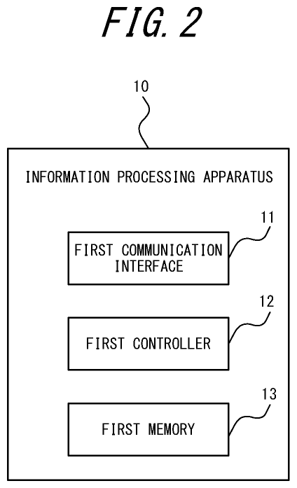

As illustrated in FIG. 2, the information processing apparatus 10 according to the embodiment of the present disclosure includes a first communication interface 11, a first controller 12, and a first memory 13. As the information processing apparatus 10, a general purpose computer, such as a Personal Computer (PC), can be used. The information processing apparatus 10 is not limited to a single type of hardware, and may be configured by a plurality of types of hardware connected by a Local Area Network (LAN) or the like. A plurality of types of hardware equipped with the functions of the information processing apparatus 10 can also be arranged in a geographically distributed manner via the communication network 40.

The first communication interface 11 includes a communication interface for connection to the communication network 40. The communication interface may be compliant with any one or more of various communication standards, such as a wired LAN, a wireless LAN, an optical communication line, or a digital subscriber line. The information processing apparatus 10 is connected to the communication network 40 via the first communication interface 11.

The first controller 12 includes a single processor or a plurality of processors. In the present disclosure, processors include general purpose processors that execute programmed functions by loading a program, and dedicated processors that are dedicated to specific processing. Dedicated processors may include Digital Signal Processors (DSPs), Application Specific Integrated Circuits (ASICs), Field-Programmable Gate Arrays (FPGAs), or the like.

The first controller 12 controls operations of the entire information processing apparatus 10. The first controller 12 can transmit and receive information to and from the vehicles 20 and the systems 41 of the operators via the first communication interface 11. The first controller 12 can further transmit and receive information to and from the operation management system 42 and the diagnostic information analysis system 43 via the first communication interface 11. The first controller 12 can store, in the first memory 13, information that is acquired via the first communication interface 11. The first controller 12 can execute various processes on the information stored in the first memory 13.

The first memory 13 stores any information used for the operations of the information processing apparatus 10. The first memory 13 may include a semiconductor storage device, a magnetic storage device, and/or an optical storage device. The semiconductor storage device may include Read Only Memory (ROM), Random Access Memory (RAM), flash memory, and/or another type of memory.

The first memory 13 stores information on a service group including a plurality of services that can be provided by the service providing operators. Service information, which is information on respective services included in the service group, may be acquired and updated through the systems 41 of the service providing operators via the communication network 40. The information processing apparatus 10 may also include an input means through which the service information for the service providing operators can be inputted.

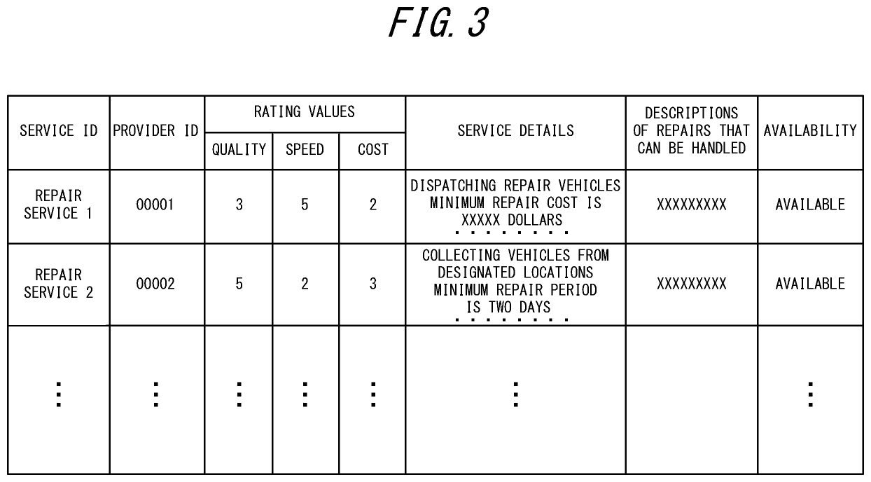

As an example, the information on the service group stored in the first memory 13 is illustrated in FIG. 3. In this example, information on each service included in the service group includes a service ID, which is information for identifying the service, and a provider ID, which is information for identifying a service providing operator that provides the service. Further, information on each service includes rating values for a plurality of evaluation categories with respect to the service. The plurality of evaluation categories includes, for example, “quality”, “speed”, and “cost.” The rating values indicate, for example, levels of evaluation by a plurality of grades. The plurality of grades is, for example, on a scale of one to five or one to ten. The rating values may be expressed as score data. For example, the higher the quality of the service, the higher the rating value for “quality.” The service quality can be evaluated as high when the service providing operator has high technical capabilities, or when warranty for repaired parts is satisfactory. For example, the shorter the time taken to complete a repair or provide an alternative transportation means, the higher the rating value for “speed.” For example, the lower the cost relating to the service, the higher the rating value for “cost.” Rating values may be given by the operator of concierge services that operates the information processing apparatus 10. Rating values may reflect information on evaluation that is collected from users who have used the services.

Information on each service may include information indicating details of the service. The information indicating the details of the service may be transmitted to a vehicle 20 or the operation management system 42 to be presented to the user, when necessary.

Information on each service may include information on descriptions of repairs that can be handled by the service providing operator. The information on the descriptions of the repairs that can be handled may be associated with failure diagnosis information that the first controller 12 acquires from vehicles 20. Using this information, the first controller 12 can only extract services that can deal with failure descriptions indicated by the failure diagnosis information acquired from the vehicles 20.

Information on each service may include information on “availability.” The information on “availability” indicates whether the service can be currently used. For example, in a case in which a repair shop of a service providing operator that provides a repair service is fully occupied and cannot take on a new repair, the “availability” of this service is considered “unavailable.” Similarly, in a case in which the service providing operator is closed, the “availability” is considered “unavailable.” On the other hand, in a case in which the service can be currently used, the “availability” is considered “available.” In the information processing apparatus 10, whether it is “available” and “unavailable” may be represented by a symbol, such as 0 or 1. The first controller 12 may acquire the information on the availability from the system 41 of the operator via the first communication interface 11, and update information on “availability” included in information on the service stored in the first memory 13 to the latest information.

Information on each service may further include positional information for a repair shop of the service providing operator. The positional information for the repair shop may be used to determine whether the repair shop is within a travelable range of a vehicle 20 in which a failure has occurred, in a case in which the vehicle 20 has a limited travelable distance.

The first memory 13 further stores user information regarding the users of the plurality of vehicles 20 who use services provided by the information processing apparatus 10. Information on each user included in the user information may be information registered in advance by the user. The user information may be registered from general purpose information terminals, such as personal computers held by the users, via the communication network 40.

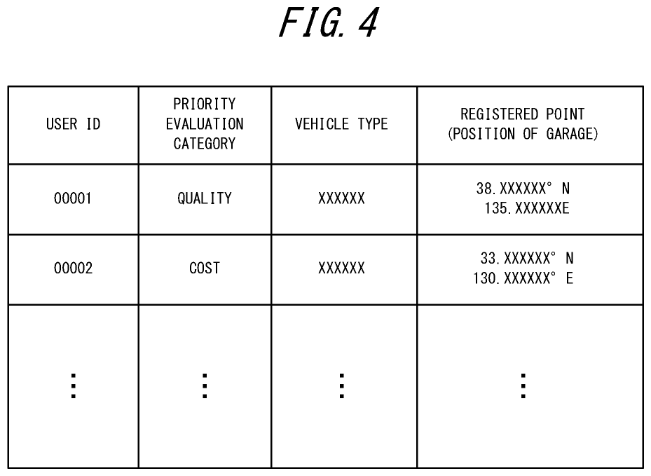

As an example, the user information stored in the first memory 13 is illustrated in FIG. 4. The user information includes, for each user, a “user ID” that is information for identifying the user. The user information includes, for each user, a specific setting for “priority evaluation category” that is information indicating an evaluation category that the user prioritizes when they use services. The “priority evaluation category” is, for example, selected from a group of evaluation categories including “quality”, “speed”, and “cost.” In a case in which the “priority evaluation category” of the user is “quality”, this means that the user wants to select a service by prioritizing quality. The information on “priority evaluation category” may be registered by the user. Alternatively, the information on “priority evaluation category” can be determined by the first controller 12, by analyzing a user's tendency toward using the services.

Further, the user information may include, for each user, information on “vehicle type” indicating the type of a vehicle 20 used by the user, and information on “registered point” indicating a position in which the vehicle 20 is normally stored. The information on “vehicle type” may be used to analyze failure diagnostic information, to determine a repair description, to extract service providing operators that can handle the repair, or the like. The information on “registered point” is used as a dispatch point for a repair vehicle or a towing vehicle, in a case in which a failure of the vehicle 20 has occurred in a garage or the like, or in a case in which the vehicle 20 can return to the garage by emergency driving. The information on the registered point may be used to identify whether the failure of the vehicle 20 has occurred in the garage or at its destination, by comparing it with positional information for the vehicle 20 in which the failure has occurred.

The first controller 12 can extract one or more service candidates that can be provided from the service group stored in the first memory 13, based on failure diagnosis information and positional information for a vehicle 20 in which a failure has occurred. The service candidates are extracted from services that can deal with a failure description according to the failure diagnosis information. Only those services that are available may be extracted as the service candidates, from the column “availability” included in the service information. Failure repair services may include multiple types of services, such as services for dispatching repair vehicles, services for repairing vehicles 20 at repair shops after the vehicles 20 have travelled there in the emergency driving mode, or the like.

The services that are extracted by the first controller 12 include not only the repair services but also other services. For example, the other services may include vehicle removal services using towing vehicles or the like in a case in which vehicles 20 are unable to move due to breakdowns on roads or the like. When it is assumed that a user is in need of a transportation means that is to substitute for a vehicle 20 in which a breakdown has occurred, services for providing alternative transportation means, such as alternative vehicle rental services, may be included. Depending on the type of the breakdown, in a case in which oil leakages or the like has contaminated a road, parking lot, or the like, cleaning services for cleaning roads or the like may be included.

Further, the first controller 12 selects one or more services from the plurality of extracted service candidates, based on a priority evaluation category. Based on an evaluation category prioritized by a user, the first controller 12 can select each service included in the service information to which a high rating value has been given under the evaluation category. As the evaluation category prioritized by the user, the specific setting for “priority evaluation category” in the user information can be used. The first controller 12 can preferentially select services with high rating values under the user's priority evaluation category. The first controller 12 may include an algorithm for determining services with high rating values under the priority evaluation category from those under a plurality of evaluation categories.

(Configuration of Vehicle)

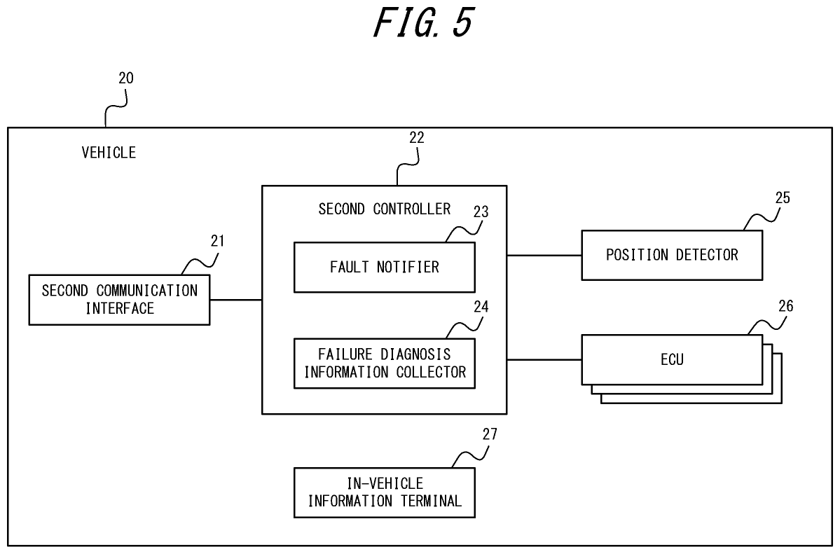

As illustrated in FIG. 5, each vehicle 20 according to the embodiment includes a second communication interface 21 and a second controller 22.

The second communication interface 21 communicates with an external system via the communication network 40. The second communication interface 21 may include a wireless communication device and an antenna for connection to the communication network 40 so as to perform communications. The second communication interface 21 is compliant with a mobile communication standard, including the 4th generation (4G) standard and the 5th generation (5G) standard, but these examples are not limiting. The second communication interface 21 may be compliant with a wireless Local Area Network (LAN) standard.

The second controller 22 is configured with at least one processor, as is the case with the first controller 12. The second controller 22 can communicate with the components in the vehicle 20 via a network, such as a Controller Area Network (CAN), in the vehicle 20. The second controller 22 includes a fault notifier 23 and a failure diagnosis information collector 24. The fault notifier 23 and the failure diagnosis information collector 24 may be software modules that operate in the second controller 22.

When a fault occurs in the vehicle 20, the fault notifier 23 causes the failure diagnosis information collector 24 to collect failure diagnosis information. The fault notifier 23 transmits the failure diagnosis information that has been collected by the failure diagnosis information collector 24, together with current positional information for the vehicle 20, to the information processing apparatus 10 directly via the second communication interface 21 or indirectly via the diagnosis information analysis system 43. The fault notifier 23 may detect a fault that has occurred in the vehicle 20. For example, the fault notifier 23 detects the fault, based on information detected by various sensors in the vehicle 20. The fault notifier 23 may recognize the fault by a user or passenger of the vehicle 20 pressing an emergency call button located in the vehicle 20. In a case in which the vehicle 20 is a passenger transportation vehicle, the fault notifier 23 may be configured to be activated from the operation management system 42 of the vehicle 20.

The fault notifier 23 acquires current positional information for the vehicle 20 from the position detector 25 in the vehicle 20. The position detector 25 detects, for example, an absolute position of the vehicle 20 defined by a latitude and longitude, or the like. The position detector 25 can acquire information on the latitude and longitude at the current position of the vehicle 20 using signals from a GPS receiver. The GPS receiver can measure the position of the vehicle 20 using satellites. As the position detector 25, instead of or in addition to the GPS receiver, a receiver compliant with a different Global Navigation Satellite System (GNSS) may be employed. The different GNSS includes, for example, a satellite positioning system using quasi-zenith satellites.

When a failure occurs, the failure diagnosis information collector 24 collects diagnosis information from Electronic Control Units (ECUs) 26, which are electronic control devices for various components in the vehicle 20, including the motor, engine, transmission, battery, or the like. When a fault occurs, each ECU 26 automatically records diagnostic information about the fault by a self-diagnostic capability. The self-diagnostic capability is also referred to as On-Board Diagnostics (ODB).

The vehicle 20 further has an in-vehicle information terminal 27 mounted therein. The in-vehicle information terminal 27 includes a display apparatus and a processor. The in-vehicle information terminal 27 may be configured to be connectable to the communication network 40 using its own communication capability or by using the second communication interface 21. The in-vehicle information terminal 27 may be independent of the rest of the vehicle 20.

(Processing of Information Processing Apparatus)

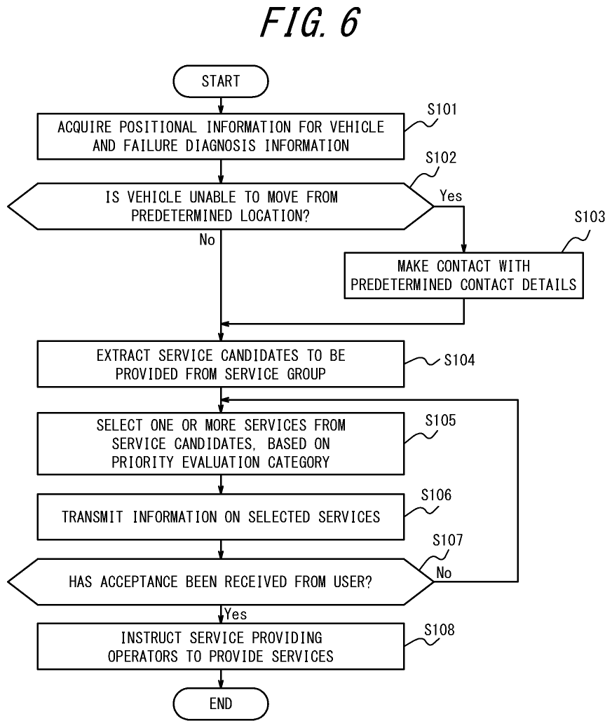

Processing executed by the first controller 12 of the information processing apparatus 10 will be described, with reference to a flowchart in FIG. 6. The processing can be executed according to a program by a processor included in the information processing apparatus 10. Such a program may be stored in a non-transitory computer readable medium. Examples of non-transitory computer readable media may include, but are not limited to, a hard disk, RAM, ROM, flash memory, a CD-ROM, an optical storage device, and a magnetic storage device.

The first controller 12 acquires positional information and failure diagnosis information for a vehicle 20 in which a failure has occurred (Step S101). The failure diagnosis information may be acquired directly from the vehicle 20 or via the diagnostic information analysis system 43. The first controller 12 may execute processing for analyzing the acquired failure diagnosis information further. Based on the failure diagnosis information, the first controller 12 can recognize the condition of the vehicle 20, including whether the vehicle 20 is able to move.

Based on the acquired positional information and failure diagnosis information, the first controller 12 determines whether the vehicle 20 in which the failure has occurred is unable to move from a predetermined location on a highway or the like (Step S102). The predetermined location is a location at which it is desirable to contact an administrator of roads, facilities, or the like for safety or other reasons. The predetermined location may be registered in the first memory 13 in advance.

When it is determined that the vehicle 20 is unable to move from the predetermined location (Step S102: Yes), the first controller 12 may transmit, via the first communication interface 11, a message notifying a system of the administrator or the like of roads or facilities that the vehicle 20 is unable to move (Step S103). In a case in which the vehicle 20 has been removed by a towing vehicle dispatched by the administrator or the like of roads or facilities, the first controller 12 may receive information on a place to which the vehicle 20 has been removed, via the first communication interface 11. When it is determined that the vehicle 20 is not unable to move from the predetermined location (Step S102: No), and after contact is made with predetermined contact details at Step S103, the first controller 12 proceeds to Step S104.

The processing of Step S102 and the processing of Step S103 are not essential. After Step S101, the first controller 12 may proceed directly to Step S104.

In Step S104, the first controller 12 extracts, from a group of services included in service information stored in the first memory 13, service candidates that can be provided to the vehicle 20 in which the failure has occurred. As described above, the first controller 12 extracts services that can deal with a failure description determined from the failure diagnosis information acquired from the vehicle 20. In a case in which the service information includes information on availability, only those services that are currently available are extracted. The first controller 12 may also combine various services as the extracted services. For example, in a case in which the vehicle 20 is unable to move from a location other than a garage of the vehicle 20 that is registered as the registered point, the first controller 12 can extract a combination of a vehicle removal service, a repair service, and a service for providing an alternative transportation means.

Next, the first controller 12 selects one or more services from the extracted service candidates, based on a priority evaluation category that has been registered in the user information in advance and on respective rating values under evaluation categories that are included in information on each service (Step S105). For example, it is assumed that a failure has occurred at a location other than the registered point (garage) of the vehicle 20 and that a distance that can be traveled in the emergency driving mode is short. In a case in which the priority evaluation category is “quality”, a service provided by an operator with highly skilled mechanics may be selected from among services for removing vehicles to repair shops using towing vehicles so as to get them repaired. In a case in which the priority evaluation category is “cost”, a less expensive service may be selected from among services for repairing vehicles 20 at repair shops located within ranges that the vehicles 20 can travel in the emergency driving mode. In a case in which the priority evaluation category is “speed”, a service that guarantees a short delivery time may be selected from among services for dispatching repair vehicles and carry out repairs on the spot, or from among services for removing vehicles to repair shops using towing vehicles so as to get them repaired.

Upon selecting services, the first controller 12 transmits information on the selected services to a terminal or system of the user that has been registered in advance (Step S106). The information on the services can include information on “service details” that has been registered in the service information. In a case in which the vehicle 20 is a vehicle owned by an individual, the terminal or system of the user that has been registered in advance can be an in-vehicle information terminal 27 in the vehicle 20, or a mobile phone (smartphone) or portable information terminal held by the user. A navigation system in the vehicle 20 or another system may be used in common as the in-vehicle information terminal 27. Information processing performed by the in-vehicle information terminal 27 may be executed by the second controller 22. In a case in which the vehicle 20 is a vehicle owned by a passenger transportation operator, the terminal or system of the user that has been registered in advance can be the operation management system 42 or a particular computer included in the operation management system 42. The passenger transportation operator may receive information on the selected services via the operation management system 42.

Upon receiving the information of the selected services from the information processing apparatus 10, the terminal or the system of the user may display an image showing the details of the services to the user so as to request acceptance. The terminal or system of the user may be loaded with a dedicated application for transmitting and receiving information to and from the information processing apparatus 10. In a case in which a signal indicating that the user is not to accept use of the services has been received (Step S107: No), the first controller 12 of the information processing apparatus 10 returns to Step S105 and repeats Steps S105 through S107. In a case in which a signal indicating that the user is to accept use of the services has been received (Step S107: Yes), the first controller 12 of the information processing apparatus 10 instructs the systems 41 of the service providing operators to provide the services to the user (Step S108).

As described above, according to the present embodiment, because the first controller 12 extracts service candidates to be provided from a service group stored in the first memory 13 based on failure diagnosis information, it is possible to extract appropriate service candidates relevant to the failure description. Further, because the first controller 12 selects one or more services from the service candidates, based on a priority evaluation category indicating an evaluation category for each service that is prioritized by a user, it is possible to present to the user those services that match evaluation criteria prioritized by the user. Consequently, the information processing apparatus 10 according to the present disclosure can assist a user in recovery from a failure when it occurs in a vehicle 20.

### Second Embodiment

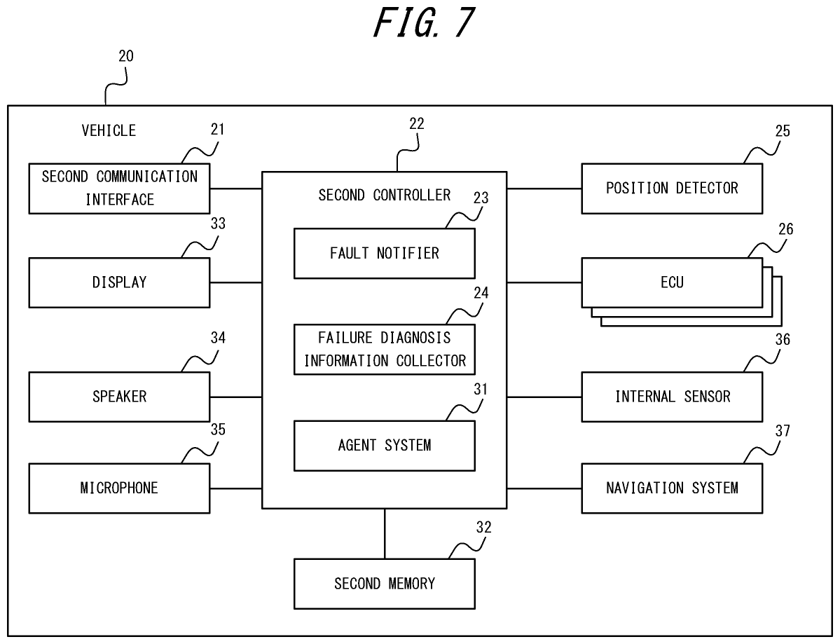

An information processing system 1 according to a second embodiment of the present disclosure will be described, with reference to FIG. 7 to FIG. 9. In the second embodiment, a configuration inside each vehicle 20 differs from that in the first embodiment. In the second embodiment, components that are the same as or similar to those of the first embodiment are denoted by the same reference numerals as the corresponding components of the first embodiment, and a description overlapping that of the first embodiment will be omitted. In the second embodiment, each vehicle 20 is described as being a vehicle owned by an individual.

Each vehicle 20 in the present embodiment includes an agent system 31, instead of the in-vehicle information terminal 27. The agent system 31 may be included in the second controller 22. The agent system 31 may be a software module that runs on a processor constituting the second controller 22. The agent system 31 may be executed by a processor that is the same as, or different from, a processor that executes the functions of the fault notifier 23 and the failure diagnosis information collector 24.

The agent system 31 may be configured to interact with a user via a display 33, a speaker 34, and a microphone 35 that are provided in the vehicle. The agent system 31 can collect information indicating a mode in which the vehicle 20 is used as vehicle use information, from the components of the vehicle 20, including an internal sensor 36 and a navigation system 37. The agent system 31 may be capable of predicting the evaluation category prioritized by the user, based on the vehicle use information.

The agent system 31 executes processing for presenting information using images, sound, or the like to a user of the vehicle 20. For example, the agent system 31 generates an image to be displayed to the user. The agent system 31 causes an image to be displayed, by transmitting image signals to the display 33 provided in the vehicle 20. As the display 33, various types of displays, such as a Liquid Crystal Display (LCD) or an organic Electro-Luminescent (EL) display, may be used. The display 33 may also be a Head Up Display (HUD).

For example, the agent system 31 synthesizes audio as information to be presented to a user. The agent system 31 can cause audio to be outputted, by transmitting audio signals to the speaker 34 provided in the vehicle 20. The speaker 34 converts the audio signals into physical vibrations to thereby generate sound in space. As the speaker 34, an audio speaker installed in the vehicle 20 may be used.

The agent system 31 performs processing for receiving an input from a user of the vehicle 20. For example, the agent system 31 performs voice recognition processing on voice signals from the user that have been acquired through the microphone 35 in the vehicle 20. One or more microphones 35 can be placed in the cabin of the vehicle 20. The microphones 35 can be placed at various positions in the cabin. For example, the microphones 35 can be placed in various positions, such as on the ceiling of the cabin, on the steering column, on the dashboard, or on the door.

For example, the agent system 31 can acquire information inputted by a user through a touch panel provided on the display 33. The touch panel is a device that detects an input in response to a touch by the user. The touch panel is configured as an integral part of the display 33 and accepts an input in conjunction with the content shown on the display 33.

The internal sensor 36 include, for example, a seating sensor and a weight sensor. The seating sensor is a sensor that detects that a passenger is sitting on a seat. The seating sensor may include pressure sensitive sensors embedded in the respective seats of the vehicle 20. Upon detecting a pressure of a predetermined value or more, the seating sensor detects that a passenger is sitting on a seat. The seating sensor can be used to detect the count of persons on board the vehicle 20. Such a sensor for detecting the count of persons on board the vehicle 20 is not limited to the seating sensor. The weight sensor may detect the weight in the trunk. The weight sensor detects whether a user is carrying heavy luggage.

The navigation system 37 is a system that gives a user route guidance to their destination. From the navigation system 37, the agent system 31 can acquire information on the current position of the vehicle 20 and its destination. The agent system 31 may also acquire information on daily driving of the user from the navigation system 37 and accumulate it in the second memory 32. Further, in a case in which the navigation system 37 is linked to a schedule management system for the user, the agent system 31 may acquire schedule information for the user from the navigation system 37.

The second memory 32 stores information necessary for processing executed by the second controller 22, including the agent system 31. The second memory 32 may store travel history information for the vehicle 20 in a sequential order. The travel history information may include information on times at which the vehicle 20 has travelled and its destinations. The second memory 32 may include a semiconductor storage device, a magnetic storage device, and/or an optical storage device, as is the case with the first memory 13. The second memory 32 may store information for a user who uses the vehicle 20 regarding their past use of the vehicle.

The agent system 31 can determine a mode in which the vehicle 20 is used by a user of the vehicle 20. For example, the agent system 31 can recognize a use pattern, such as times during which the vehicle 20 is used or its destinations, from the driving history information stored in the second memory 32. For example, in a case in which the user travels to the same place at the same time every day from Monday to Friday by vehicle 20, the agent system 31 can recognize this.

The agent system 31 can predict a purpose of use of the vehicle 20 by a user who boards the vehicle 20. The purpose of use of the vehicle 20 includes commuting, leisure, shopping, or the like. For example, in a case in which the vehicle 20 travels to the same destination at the same time every day from Monday to Friday, the agent system 31 can predict that the purpose of travel by the user is to commute, from the travel history information stored in the second memory 32. In a case in which the vehicle 20 is boarded by more than one person and is traveling toward a distant destination set by the navigation system 37, the agent system 31 can predict that the purpose of travel by the user is to spend leisure.

The agent system 31 can predict the next date on which the vehicle 20 will be used by a user, from a user's use pattern of the vehicle 20 based on the travel history information stored in the second memory 32 and from schedule information for the user that has been acquired from the navigation system 37. For example, in a case in which the user uses the vehicle 20 primarily only on Saturdays and Sundays, and a failure has occurred in the vehicle 20 on Sunday, the agent system 31 can predict that the next date of use of the vehicle 20 will be six days later on Saturday.

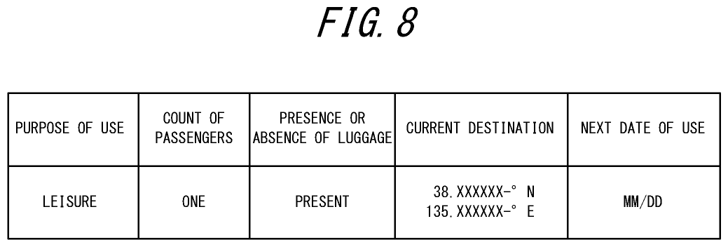

The agent system 31 can transmit detected or predicted vehicle use information to the information processing apparatus 10. The vehicle use information may include, for example, information illustrated in FIG. 8. The vehicle use information may include all or part of information on “purpose of use”, “count of passengers”, “presence or absence of luggage”, “current destination”, and “next date of use” as illustrated in FIG. 8. The vehicle use information may include information other than the above.

The first controller 12 of the information processing apparatus 10 may change a priority evaluation category from its specified setting, based on vehicle use information acquired from a vehicle 20. For example, in a case in which a vehicle 20 in which a failure has occurred is a vehicle 20 that has experienced the failure while travelling, the purpose of use is leisure, the count of passengers is more than one, and the presence or absence of luggage is “present”, the user is presumed to be in need of an immediate repair for the failure or in need of an alternative transportation means. Accordingly, the first controller 12 may change the priority evaluation category to “speed.” In a case in which a vehicle 20 in which a failure has occurred can travel to a registered point, such as a garage, in the emergency driving mode, and a predicted next date on which the vehicle will be used is more than a few days away, the user is presumed to be not in urgent need of a repair. Accordingly, the first controller 2 may change the priority evaluation category from “speed” to “quality” or “cost.”

Upon receiving information on selected one or more services from the information processing apparatus 10, the agent system 31 can present the received information on the services to a user through the display 33 and the speaker 34. The agent system 31 may receive whether the user accepts or rejects use of the services by voice through the microphone 35. In a case in which the user has not accepted use of the services, the agent system 31 may ask the user whether the priority evaluation category is to be changed and receive an answer.

In a case in which the user has accepted use of the services, the agent system 31 notifies the information processing apparatus 10 that the selected services are to be used. When the user has changed the priority evaluation category, the agent system 31 notifies the information processing apparatus 10 of the changed priority evaluation category.

(Processing of Information Processing Apparatus)

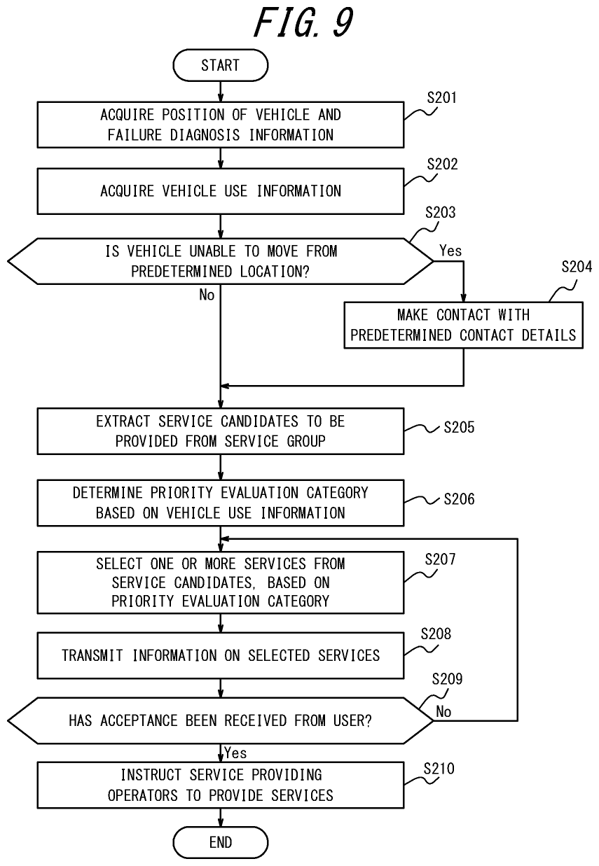

Processing executed by the first controller 12 of the information processing apparatus 10 in the second embodiment will be described, with reference to FIG. 9. In FIG. 9, Step S201, Step S203 to Step S205, and Step S207 to Step S210 are respectively the same as or similar to Step S101, Step S102 to Step S104, and Step S105 to S108 in FIG. 6, and a description of common parts of the processing will be omitted.

After acquiring a position of a vehicle and failure diagnosis information in Step S201, the first controller 12 acquires vehicle use information from the vehicle 20 (Step S202). Step S202 may be performed at the same time as Step S201.

In Step S205, the first controller 12 extracts service candidates to be provided, based on the failure diagnosis information and the vehicle use information. For example, in a case in which the vehicle 20 is boarded by more than one passenger, or in a case in which the vehicle 20 is carrying heavy luggage, services for providing alternative transportation means are extracted.

After extracting service candidates to be provided from a service group in Step S205, the first controller 12 determines a priority evaluation category based on the vehicle use information (Step S206). Regarding the priority evaluation category, while a priority evaluation category that has been set in the user information stored in the first memory 13 is used as its initial setting, for example, a change may be made to this initial setting based on analysis of the vehicle use information.

In Step S208, information on the selected services is transmitted to the vehicle 20. The agent system 31 of the vehicle 20 interacts with the user and receives instructions indicating whether to accept the services. In a case in which the user has not accepted use of the services, the agent system 31 may receive instructions from the user to change the priority evaluation category. In that case, the agent system 31 transmits information on a change to the priority evaluation category to the information processing apparatus 10.

In a case in which a signal indicating that the user is not to accept use of the services has been received from the vehicle 20 (Step S209: No) and information on a change to the priority evaluation category has been received, the first controller 12 executes steps from Step S207 onwards again in accordance with a new priority evaluation category. In a case in which a signal indicating that the user is to accept use of the services has been received (Step S109: Yes), the first controller 12 of the information processing apparatus 10 instructs the systems 41 of the service providing operators to provide the services to the user (Step S210).

According to the present embodiment, services to be extracted by the information processing apparatus, and a priority evaluation category for evaluating each service are changed in accordance with a mode in which a vehicle is used by a user. This enables provision of services in accordance with different situations of a user of a vehicle 20 in which a failure has occurred, thereby improving convenience for the user.

Additionally, the present disclosure is not limited to the above embodiments, and various modifications and revisions may be implemented. For example, functions or the like included in each means, each step, or the like can be rearranged without logical inconsistency, and a plurality of means, steps, or the like can be combined together or divided.

For example, in the second embodiment, the agent system 31 may determine a priority evaluation category by the agent system 31 itself from vehicle use information, instead of transmitting the vehicle use information to the information processing apparatus 10. The agent system 31 may transmit, to the information processing apparatus 10, the priority evaluation category determined by the agent system 31, instead of the vehicle use information. Upon acquiring the priority evaluation category from the agent system 31, the first controller 12 of the information processing apparatus 10 may use the acquired priority evaluation category to select services, instead of using a specific setting for the priority evaluation category included in the user information.

For example, although in the second embodiment a vehicle 20 is described as being a vehicle owned by an individual, the vehicle 20 may be a passenger transportation vehicle, such as a bus. In that case, vehicle use information may include information on the type of operation of the vehicle, an operation status, and/or the count of passengers. The type of operation of the vehicle includes a distinction between a route bus, a chartered bus, or the like. The operational status includes a distinction between being in service or out of service. For example, in a case in which the type of operation of a vehicle 20 that may not be able to be driven due to a failure is a route bus and it has many passengers, the first controller 12 of the information processing apparatus 10 that has acquired vehicle use information may set the priority evaluation category to “speed” in Step S206.

1. An information processing apparatus, comprising:
a first communication interface configured to be able to acquire failure diagnosis information for a vehicle;
a first memory configured to store information on a plurality of services; and
a first controller configured to select one or more services from the plurality of services stored in the first memory, based on the failure diagnosis information and on a priority evaluation category indicating an evaluation category for the plurality of services that is prioritized by a user of the vehicle, and transmit information on the selected one or more services to the user via the first communication interface.

2. The information processing apparatus according to claim 1, wherein the priority evaluation category is selected from a group including cost, quality, and/or speed.

3. The information processing apparatus according to claim 1, wherein the plurality of services includes a vehicle repair service, a vehicle removal service, a service for providing an alternative transportation means, and/or a cleaning service.

4. The information processing apparatus according to claim 1, wherein the first controller is configured to extract service candidates to be provided from the plurality of services stored in the first memory based on the failure diagnosis information, and select the one or more services from the service candidates based on the priority evaluation category.

5. The information processing apparatus according to claim 1, wherein the first memory is configured to store information indicating availability of each service in the plurality of services, and the first controller is configured to only extract services that are available from the plurality of services stored in the first memory, based on the information indicating the availability.

6. The information processing apparatus according to claim 1, wherein, in a case in which it is determined that the vehicle is unable to move from a predetermined location, the first controller is configured to send a notification to predetermined contact details.

7. The information processing apparatus according to claim 1, wherein the first controller is further configured to acquire vehicle use information indicating a mode in which the vehicle is used by the user from the vehicle via the first communication interface, and select the one or more services based on the failure diagnosis information, the priority evaluation category, and the vehicle use information.

8. The information processing apparatus according to claim 7, wherein, in a case in which the vehicle is a vehicle owned by an individual, the vehicle use information includes a purpose of use of the vehicle, a count of passengers, presence or absence of luggage, a current destination, and/or a predicted next date on which the vehicle is to be used.

9. The information processing apparatus according to claim 7, wherein, in a case in which the vehicle is a passenger transportation vehicle, the vehicle use information includes information on type of operation of the vehicle, an operation status, and/or a count of passengers.

10. The information processing apparatus according to claim 7, wherein the first controller is configured to change the priority evaluation category, based on the vehicle use information that has been acquired from the vehicle.

11. The information processing apparatus according to claim 1, wherein the first controller is configured to acquire the priority evaluation category from the vehicle via the first communication interface.

12. A vehicle, comprising:
a second communication interface configured to be communicable with the outside; and
a second controller configured to be able to collect failure diagnosis information when a failure occurs, and transmit the failure diagnosis information directly or indirectly to an external information processing apparatus via the second communication interface, wherein
the second controller is further configured to be able to transmit, to the information processing apparatus, vehicle use information indicating a mode in which the vehicle is used by a user of the vehicle, and acquire, from the information processing apparatus, information on one or more services that have been selected from a plurality of services based on the failure diagnosis information, a priority evaluation category indicating an evaluation category for the plurality of services that is prioritized by the user, and the vehicle use information.

13. The vehicle according to claim 12, wherein the priority evaluation category is selected from a group including cost, quality, and/or speed.

14. The vehicle according to claim 12, comprising
a second memory configured to be able to accumulate travel history information including times at which the vehicle has traveled and destinations in a sequential order, wherein,
in a case in which the vehicle is a vehicle owned by an individual, the vehicle use information includes a purpose of use of the vehicle, and the second controller is configured to be able to predict the purpose of use of the vehicle based on the accumulated travel history information.

15. The vehicle according to claim 12, wherein, in a case in which the vehicle is a vehicle owned by an individual, the vehicle use information includes information on a count of passengers, presence or absence of luggage, a destination, and/or a predicted next date on which the vehicle is to be used.

16. The vehicle according to claim 12, wherein, in a case in which the vehicle is a passenger transportation vehicle, the vehicle use information includes information on type of operation of the vehicle, an operation status, and/or a count of passengers.

17. The vehicle according to claim 12, wherein the second controller is configured to determine the priority evaluation category based on the vehicle use information, and transmit the determined priority evaluation category to the information processing apparatus.

18. An information processing system comprising:
an information processing apparatus; and
a vehicle configured to collect failure diagnosis information when a failure occurs, and transmit the failure diagnosis information to the information processing apparatus, wherein
the information processing apparatus is configured to store information on a plurality of services, select one or more services from the plurality of services, based on the failure diagnosis information for the vehicle and on a priority evaluation category indicating an evaluation category for the plurality of services that is prioritized by a user of the vehicle, and transmit information on the selected one or more services to the user.

19. The information processing system according to claim 18, wherein the priority evaluation category is selected from a group including cost, quality, and/or time.

20. The information processing system according to claim 18, wherein the vehicle is configured to be able to generate vehicle use information indicating a mode in which the vehicle is used by the user, and transmit the vehicle use information to the information processing apparatus, wherein the information processing apparatus is configured to select the one or more services based on the failure diagnosis information, the priority evaluation category, and the vehicle use information.
